(19) United States
(12) Patent Application Publication
(10) Pub. No.: US 2019/0029189 A1
(43) Pub. Date: Jan. 31, 2019

(54) CULTIVATION SHELF AND PLANT CULTIVATION FACILITY

(71) Applicant: Mitsubishi Chemical Corporation, Chiyoda-ku (JP)

(72) Inventors: Akira MAKI, Chiyoda-ku (JP); Satoru Izumisawa, Chiyoda-ku (JP)

(73) Assignee: Mitsubishi Chemical Corporation, Chiyoda-ku (JP)

(21) Appl. No.: 16/145,550

(22) Filed: Sep. 28, 2018

Related U.S. Application Data
(63) Continuation of application No. PCT/JP2017/007099, filed on Feb. 24, 2017.

(30) Foreign Application Priority Data
Mar. 30, 2016 (JP) 2016-068706

(51) Int. Cl. A01G 9/24; A01G 9/02; A01G 9/20

(52) U.S. Cl. CPC A01G 9/246; A01G 9/20; A01G 9/023

(57) ABSTRACT

Provided is a plant cultivation facility capable of keeping the temperature around plants in the optimum cultivation range. Provided is a plant cultivation facility comprising a cultivation shelf and an air conditioner in a chamber having a floor, side walls, and a ceiling, wherein an air blow part of the air conditioner is disposed on a side wall of the chamber, and wherein a suction part is disposed on a side wall surface opposed to said side wall surface; the plant cultivation shelf including: a holding container, a lighting device, and a support structure including a plurality of stages which are arranged in heightwise direction and each include, a supporting surface and a ceiling surface; wherein ΔT, obtained according to a particular mathematical equation (1) using an effective shelf-to-shelf height (H) and an effective shelf width (D), is 10° C. or less.

### CROSS-REFERENCE TO RELATED APPLICATION

This is a continuation of International Application No. PCT/JP2017/007099, filed on Feb. 24, 2017, and designated the U.S., and claims priority from Japanese Patent Application No. 2016-068706 which was filed on Mar. 30, 2016, the entire contents of which are incorporated herein by reference.

### TECHNICAL FIELD

The present invention relates to a cultivation shelf capable of enhancing space efficiency and providing growth condition suitable for plants, and a plant cultivation facility provided with the cultivation shelf.

### BACKGROUND ART

In recent years, a plant factory has drawn attention as a means of industrial production of plants, and various cultivation shelves for cultivating plants have also been proposed. Conventionally, cultivation shelves used in plant factories are those provided with multistage cultivation tanks in which plants are to be planted, as well as lighting devices capable of irradiating light to plants placed above the cultivation tanks of each stage.

Fluorescent lamps, LEDs, and the like have been used as conventional cultivating lighting devices, but they are suffering from problems that the surface temperature of the lighting device becomes high. Therefore, it is necessary to eliminate the influence of heat by sufficiently separating the lighting device from the plant. However, when the lighting device is separated so far away from the plant, the light amount reaching to the plant decreases, affecting the growth of the plant. Accordingly, it is necessary to keep a certain irradiation distance.

Considering such problems, various cultivation shelves have been proposed.

Patent Literature 1 discloses a multistage cultivation shelf equipped with artificial light sources which can be moved up and down in accordance with the growth of plants wherein air conditioning equipment is provided in each stage.

Patent Literature 2 describes a cultivation shelf in which a lighting device is provided so as to be movable up and down to maintain a proper irradiation distance according to the height of the growing plant. In addition, bellows which blow conditioned air are provided on the side surface for each stage of the cultivation shelf.

Patent Literature 3 discloses a cultivation shelf having a lift including a lighting device and an air blowing device, and describes that the plant cultivation efficiency shall be greatly improved by placing the lighting device and the air blowing device as close to the plants as possible at any time.

### CITATION LIST

### Patent Literature

Patent Literature 1: Japanese Patent Laid-Open No. 2010-88425

Patent Literature 2: Japanese Patent Laid-Open No. 2013-44

Patent Literature 3: Japanese Patent Laid-Open No. 2011-205991

### SUMMARY OF INVENTION

### Technical Problem

The present inventors have attempted plant cultivation using multistage cultivation shelves, and have found that an uneven temperature distribution occurs in the air blowing direction in a shelf-to-shelf space in which plants are to be placed when the plants are cultivated in the space to which the air conditioned by an air conditioner is blown.

On the other hand, when planning industrial production using a multistage cultivation shelf in a plant factory in order to increase the space efficiency, it is required for the shelf-to-shelf height for each stage to be reduced as low as possible to increase number of stages and it is also required for the shelf width of a cultivation shelf to be increased as large as possible. However, when shelf-to-shelf height is too low and/or the shelf width is too wide, the heat generated by the lighting device heats the air around the plant to excessively high temperature, which shall interfere plant cultivation. Particularly, when attempting to scale up the cultivation shelf by expanding the shelf width, the influence of uneven temperature distribution in the air blowing direction becomes prominent, which likely causes a problem.

Although all of Patent Literature 1 to 3 study a measure to reduce the influence of heat generated by a lighting device, they fail to consider an uneven temperature distribution in the direction parallel to the shelf surface, particularly in the air blowing direction around the plant. In addition, the influence of the heat generated by a lighting device is not considered in the study of scale-up of a cultivation shelf.

A subject of the present invention is to provide a cultivation shelf capable of keeping the temperature around plants within the optimum range for cultivation in consideration of an uneven temperature distribution in the air blowing direction. In particular, it is preferable to be able to provide a cultivation shelf capable of increasing the space efficiency in a plant factory by scaling up compared with the conventional cultivation shelves.

### Solution to Problem

As a result of intensive investigation to solve the above-mentioned problems, the present inventors have found that a cultivation shelf designed so that the effective shelf-to-shelf height (H) and the effective shelf width (D) satisfy a specific relational expression and a plant cultivation facility having the cultivation shelf can solve the above problems, and have attained the present invention.

That is, the essential point of the present invention is as follows.
[1] A plant cultivation facility which comprises a cultivation shelf and an air conditioner in a chamber having a floor, side walls, and a ceiling, wherein an air blow part of the air conditioner is disposed on a side wall surface of the chamber so that the air in the whole chamber can be conditioned, and wherein an air suction part is disposed on a side wall surface opposed to said side wall surface; the plant cultivation shelf comprising:

a holding container for holding a plant,

a lighting device, and

a support structure including a plurality of stages which are arranged in heightwise direction and each include:
a supporting surface on which the holding container may be placed, and
a ceiling surface which is opposed to the supporting surface and on which the lighting device may be placed above the holding container;
wherein ΔT, obtained according to a mathematical expression (1) below using an effective shelf-to-shelf height (H) and an effective shelf width (D), is 10° C. or less, wherein, in the mathematical equation (1), (H) is an effective shelf-to-shelf height, i.e., a distance between a top end surface of the holding container and a ceiling surface immediately above the container, and (D) is an effective shelf width obtained according to a mathematical equation (2), i.e., a distance in the direction parallel to an air blowing direction at the holding container placed in the support structure:

$$\begin{matrix}[ Math 1 ] & \\ Δ T = \{ \begin{matrix}710.8 \frac{{L}_{1} {Q}^{′}}{{VH}^{1.3}} & ( b = 0 ) \\ {\sum }_{i = 1}^{b + 1} ( 710.8 \frac{{L}_{1} {Q}^{′}}{{VH}^{1.3}} ) - {\sum }_{j = 1}^{b} ( Δ {t}_{j} ) & ( b \geq 1 )\end{matrix} & ( 1 )\end{matrix}$$

(in the mathematical equation (1):
ΔT represents a net temperature increment [° C.] at a lower part of shelf-to-shelf space in a section having an effective shelf width D;
b represents the number of air inlet/outlet ports other than those at end portions,
Li represents a distance [m] between i-th and (i−1)-th air inlet/outlet ports, counted from an end portion air inlet port along the air blowing direction, i starting from 1,
Δtj represents a temperature decrement [° C.] at a j-th air inlet/outlet port among the air inlet/outlet ports provided in the cultivation shelf, counted from the end portion air inlet port along the air blowing direction, j starting from 1,
Q′ represents a heat input ratio by a lighting device,
V represents an air velocity blowing into a shelf-to-shelf space [m/s],
H represents an effective shelf-to-shelf height [mm]);

[Math 2]

D=Σᵢ₌₁^{b+1}Lᵢ (2)

(in the mathematical equation (2):
D represents an effective shelf width [m],
b represents the number of air inlet/outlet ports other than those at the end portion,
Li represents a distance [m] between i-th and (i−1)-th air inlet/outlet ports, counted from the end portion air inlet port along the air blowing direction, i starting from 1).
[2] The plant cultivation facility according to [1] described above, wherein the length (Li) between air inlet/outlet ports along the air blowing direction is 2 m or more.
[3] The plant cultivation facility according to [1] or [2] described above, wherein the effective shelf width (D) is 15 m or more.
[4] The plant cultivation facility according to any one of [1] to [3] described above, wherein the number of air inlet/outlet ports other than those at the end portion (b) is 1 or more.
[5] The plant cultivation facility according to any one of [1] to [4] described above, wherein the lightening device is a fluorescent lamp.
[6] The plant cultivation facility according to any one of [1] to [4] described above, wherein the lightening device is an LED.
[7] The plant cultivation facility according to any one of [1] to [6] described above, wherein the plant is a plant for protein synthesis.
[8] The plant cultivation facility according to any one of [1] to [7] described above, wherein the air blow part of the air conditioner is further placed on the side surface of the cultivation shelf so as to enable air-conditioning for each shelf-to-shelf space of the cultivation shelf.
[9] The plant cultivation facility according to any one of [1] to [8] described above, wherein a plurality of the cultivation shelves are arranged.
[10] A cultivation shelf used for cultivating plants in a space to which an air conditioned by an air conditioner is blown, the cultivation shelf comprising:

a holding container for holding a plant,

a lighting device, and

a support structure including a plurality of stages which are arranged in heightwise direction and each include:
a supporting surface on which the holding container may be placed, and
a ceiling surface which is opposed to the supporting surface and on which the lighting device may be placed above the holding container;
wherein ΔT, obtained according to a mathematical equation (1) below using an effective shelf-to-shelf height (H) and an effective shelf width (D), is 10° C. or less, wherein, in the mathematical equation (1),
(H) is an effective shelf-to-shelf height, i.e., a distance between a top end surface of the holding container and a ceiling surface immediately above the container, and
(D) is an effective shelf width obtained according to a mathematical equation (2), i.e., a distance in a direction parallel to an air blowing direction at the holding container placed in the support structure:

$$\begin{matrix}[ Math 3 ] & \\ Δ T = \{ \begin{matrix}710.8 \frac{{L}_{1} {Q}^{′}}{{VH}^{1.3}} & ( b = 0 ) \\ {\sum }_{i = 1}^{b + 1} ( 710.8 \frac{{L}_{1} {Q}^{′}}{{VH}^{1.3}} ) - {\sum }_{j = 1}^{b} ( Δ {t}_{j} ) & ( b \geq 1 )\end{matrix} & ( 1 )\end{matrix}$$

(in the mathematical equation (1):
ΔT represents a net temperature increment [° C.] at a lower part of shelf-to-shelf space in a section having an effective shelf width D;
b represents the number of air inlet/outlet ports other than those at end portions,
Li represents a distance [m] between i-th and (i−1)-th air inlet/outlet ports, counted from an end portion air inlet port along the air blowing direction, i starting from 1,
Δtj represents a temperature decrement [° C.] at a j-th air inlet/outlet port among the air inlet/outlet ports provided in a cultivation shelf, counted from the end portion air inlet port along the air blowing direction, j starting from 1,
Q′ represents a heat input ratio by a lighting device,
V represents an air velocity blowing into shelf-to-shelf space [m/s],
H represents an effective shelf-to-shelf height [mm]);

[Math 4]

D=Σᵢ₌₁^{b+1}Lᵢ (2)

(in the mathematical equation (2):
D represents an effective shelf width [m];
b represents the number of air inlet/outlet ports other than those at the end portion,
Li represents a distance [m] between i-th and (i−1)-th air inlet/outlet ports, counted from an end portion air inlet port along an air blowing direction, i starting from 1).
[11] The plant cultivation shelf according to [10] described above, wherein the length (Li) between air inlet/outlet ports along the air blowing direction is 2 m or more.
[12] The plant cultivation shelf according to [10] or [11] described above, wherein the effective shelf width (D) is 15 m or more.
[13] The plant cultivation shelf according to any one of [10] to [12] described above, wherein the lightening device is a fluorescent lamp.
[14] The plant cultivation shelf according to any one of [10] to [12] described above, wherein the lightening device is an LED.
[15] A plant cultivation facility which comprises the cultivation shelf according to anyone of [10] to [14] described above, and an air conditioner;

wherein an air blow part of the air conditioner is disposed on a side surface of the cultivation shelf so that air conditioning can be conducted for each shelf-to-shelf space of the cultivation shelf.
[16] The plant cultivation facility according to [15] described above, wherein a plurality of the cultivation shelves are arranged.

### Advantageous Effects of Invention

The cultivation shelf used in the present invention makes it possible to cultivate plants while keeping the temperature around the plant within the optimum range for cultivation even if there is an uneven temperature distribution in the air blowing direction, and thus enabling stable industrial production of plants with high quality. Furthermore, it is possible to provide cultivation shelves that have been scaled up as compared with the conventional ones while keeping the temperature around the plant within the optimum cultivation range. Thus, the space efficiency and productivity of the plant factory can be improved.

### BRIEF DESCRIPTION OF DRAWINGS

FIG. 1A is a perspective view of a cultivation shelves according to an embodiment of the present invention, and FIG. 1B is a schematic sectional view of a cultivation shelves according to an embodiment of the present invention.

FIG. 2 is a schematic cross-sectional view of a single stage of a cultivation shelf according to an embodiment of the present invention.

FIG. 3A is a schematic cross-sectional view of a partial structure of a single stage of a cultivation shelf on an air suction part side according to an embodiment of the present invention, and FIG. 3B is a schematic cross-sectional view of a partial structure of a single stage of a cultivation shelf on an air blow part side according to an embodiment of the present invention.

FIG. 4A is a schematic cross-sectional view and a schematic plane view of a partial structure of a cultivation shelf according to an embodiment of the present invention.

FIG. 4B is a schematic cross-sectional view and a schematic plane view of a partial structure of a cultivation shelf according to an embodiment of the present invention.

FIG. 5 is a schematic cross-sectional view of a cultivation shelf showing a result of a simulation example.

FIG. 6 is a plot of the temperature increment values (ΔT) at the lower part of the shelf-to-shelf space.

FIG. 7 is a schematic diagram showing the relationship between the air inlet/outlet ports and ΔT in the embodiment of the present invention.

### DESCRIPTION OF EMBODIMENTS

The embodiments of the present invention will be hereinafter described in detail with reference to drawings. It should be noted that the present invention is not limited to the following description, and it is possible to carry out the present invention with arbitrarily modification so long as not to change the scope of the invention. Besides, all the drawings used for the explanation schematically show the living things cultivation facility or its constitutive members according to the present invention, and may not always represent the accurate scale, shape, or the like of each constitutive member, but may be partially emphasized, enlarged, reduced, omitted or the like for better understanding. Furthermore, various numerical values used for explanation with reference to drawings are just exemplary, and various modifications can be made as necessary.

The cultivation shelf 10 used in the present invention is a cultivation shelf used for cultivating plants in a space to which an air conditioned by an air conditioner is supplied, the cultivation shelf comprising: a holding container 11 for holding a plant, a lighting device 12, and a support structure 13 which has a plurality of stages including heightwise a supporting surface 132 on which the holding container 11 may be placed and a ceiling surface 133 which is opposed to the supporting surface and on which the lighting device may be placed above the plant.

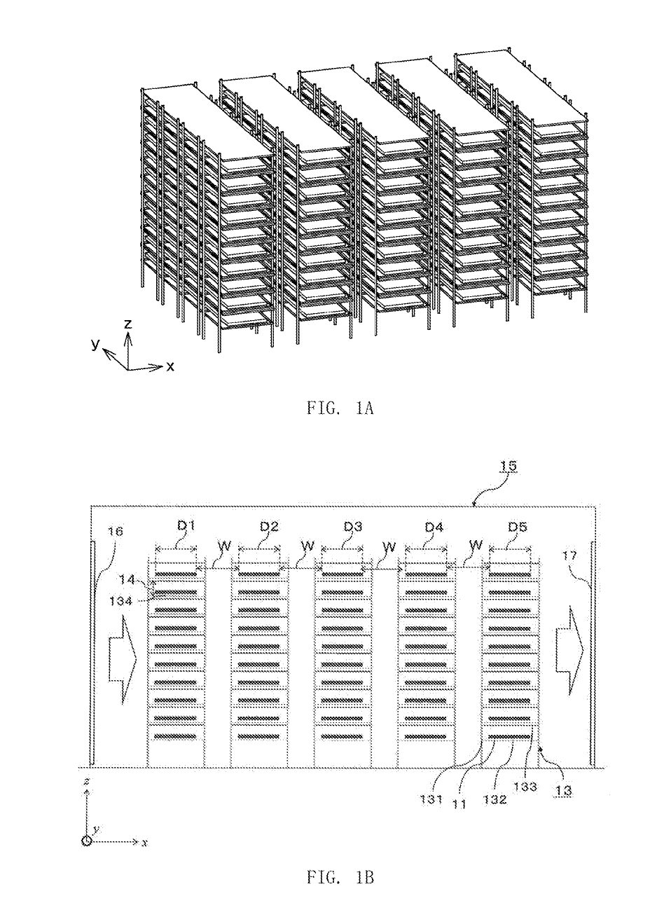

In FIG. 1B, a support structure 13 is installed in a chamber 15. The support structure 13 is a structure including a pillar 131 and a plurality of stages including heightwise supporting surfaces 132 and ceiling surfaces 133. The supporting surface 132 is a surface on which the holding container 11 is to be placed. In FIG. 1B, the supporting surface 132 of support structure 13 is formed by pillars 131 and plate-like members. But the surface may be formed only by pillars 131. In that case, the holding container 11 is directly fixed to the column 131. On the other hand, the ceiling surface 133 is a surface on which the lighting device can be placed above the holding container 11 placed on the supporting surface 132, and which is opposed to the supporting surface 132.

In FIG. 1B, the ceiling surface 133 of the support structure 13 is formed by placing a plate-like member at the lower part of the pillars 131. However, the support structure 13 may be formed only by pillars 131. In that case, the lighting device 12 is directly fixed to the pillar 131.

The space in which holding container 11 is placed and plants are to be cultivated is a shelf-to-shelf space 14 ranging from the supporting surface 132 to the ceiling surface 133. The shelf-to-shelf space 14 is formed by providing the pillar 131 constituting support surface 132 and ceiling surface 133 and providing heightwise a plurality of stages of partitioning members 134 constituted by plate-like members or the like.

FIG. 1A is a perspective view of a plurality of cultivating shelves 10 arranged in a chamber 15. In the case where the long-side direction is referred to as the y direction, the short-side direction is referred to as the x direction, and the height direction is referred to as the z direction in the cultivation shelf 10, plurality of cultivating shelves are arranged along the x direction. In this case, it is assumed that the air blowing direction of the air conditioned by an air conditioner coincides with the x direction. The air blowing direction in the embodiment is not limited to the x direction, but may be the y direction, or the direction intersecting with the x and y directions, and preferably the direction substantially perpendicular to the z direction, and preferably the direction coinciding with the x direction because the effect of the present invention will become prominent.

FIG. 1B is a schematic cross-sectional view in the y direction of a plurality of cultivation shelves 10 arranged in a chamber 15. A plurality of lighting devices 12 are provided above the holding containers 11 placed on the supporting surfaces 132 of the respective stages. A lighting device 12 is placed on a ceiling surface 133. In the drawings attached to the present specification, an open arrow indicates the air blowing direction along which the air conditioned by the air conditioner is blown.

The distance in the direction parallel to the air blowing direction in the holding container 11 placed on the support structure 13 is an effective shelf width and is indicated by D1 to D5. As shown in FIG. 1B, an air is blown in one direction from the air blow part 16 of the air conditioner placed on one side wall of the chamber 15 toward the air suction part 17 of the air conditioner placed on the other side wall, opposed to said one side wall. The air blowing direction coincides with the x direction. A chamber including an air conditioner installed therein means a chamber wherein an air blow part 16 and an air suction part 17 of the air conditioner are placed in a chamber 15, while the members constituting the air conditioner other than the air blow part 16 and the air suction part 17 may be placed outside the chamber so long as air conditioning inside the chamber can be conducted.

When the respective cultivation shelves are spaced from one another with a sufficient distance so as to prevent mutual thermal interference, the lengths D1 to D5 of the holding containers 11, coincident with the short-side direction of each cultivation shelf 10, are considered to be an effective shelf width D. When W, which denotes a distance between the respective cultivation shelves, is 2 m or more, the cultivation shelves are considered not to be mutually affected by heat generated by individual cultivation shelf since the air that has passed through the first cultivation shelf is diffused and mixed before reaching the next cultivation shelf.

On the other hand, when W is less than 2 m, it is considered that the air that has passed through the first cultivation shelf reaches the next cultivation shelf while keeping the temperature, which is considered to be comparable to the case where a plurality of cultivation shelves are arranged while connected one another. Therefore, the sum of the lengths D1 to D5 of the holding containers 11 that coincides with the short-side direction of each cultivation shelf 10 corresponds to an effective shelf width D.

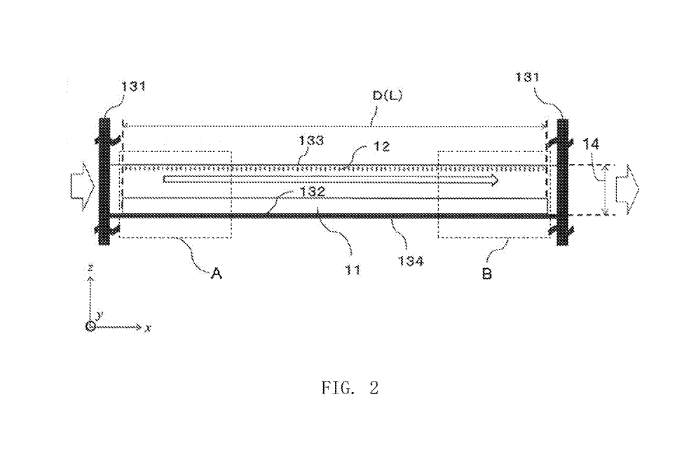

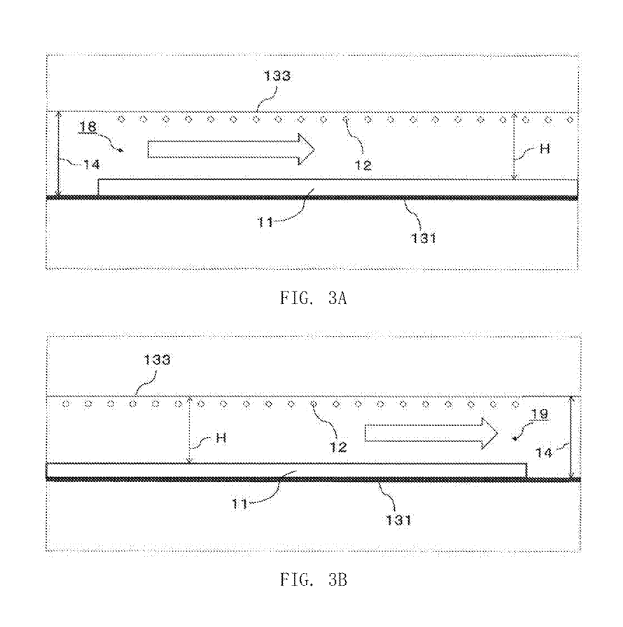

FIG. 2 is a schematic cross-sectional view in the y direction of the shelf-to-shelf space 14 of a single stage of a cultivation shelf 10. FIGS. 3A and 3B each show enlarged views of the end portions of the shelf-to-shelf space 14.

As shown in FIG. 2, a holding container 11 placed on a supporting surface 132 of a cultivation shelf 10 preferably has the width equal to or smaller than the width of a supporting surface. In FIG. 2, the air blowing direction coincides with the x direction, and the effective shelf width D coincides with the width of the holding container 11.

In FIGS. 3A and 3B, the lighting device 12 is placed on a ceiling surface 133, as shown in FIG. 2. The lighting device 12 is placed above the holding container 11, and light emitted from the lighting device 12 is appropriately irradiated on the plants present in the holding container 11.

FIG. 3A shows an end portion on an air blow part side of a cultivation shelf 10, i.e., upstream in the air blowing direction in a chamber. The holding container 11 installed in the shelf-to-shelf space 14 has a depth for holding plants, nutrient solutions, etc. The surface constituted by connecting the top end portions in the depth direction is taken as a top surface of the holding container, and the distance from the top end surface to the ceiling surface 133 immediately above the top end surface is referred to as an effective shelf-to-shelf height H. When the plant grows, it extends upward in the range of effective shelf-to-shelf height H.

In each of shelf-to-shelf spaces 14, an opening for taking in an air conditioned by an air conditioner is referred to as an end portion air inlet port 18, and an opening for allowing an air conditioned by an air conditioner to flow out is referred to as an end portion air outlet port 19. That is, in the cultivation shelf shown in FIG. 2, there are openings at both left and right ends of the shelf-to-shelf space 14. Among these openings, an opening on the upstream side in the air blowing direction shown in FIG. 3A is an end portion air inlet port 18, and the opening on the downstream side in the air blowing direction shown in FIG. 3B is an end portion air outlet port 19.

In FIG. 2, the distance from the end portion air inlet port 18 to an end portion air outlet port 19 is indicated by L1 and coincides with an effective shelf width D. In addition, when W, a distance between cultivation shelves, is less than 2 m, and a plurality of cultivation shelves 10 are placed, it is considered that the air which has passed through the first cultivation shelf reaches the next cultivation shelf while keeping the temperature, similar to the case where a plurality of cultivation shelves are connected to one another. An opening portion of the cultivation shelf closest to the air blow part 16 of the air conditioner may be taken as an end portion air inlet port 18 and the opening portion of the cultivation shelf closest to the air suction part 17 maybe taken as an end portion air outlet port 19 and the distance L from the end portion air inlet port 18 to the end portion air outlet port 19 coincides with an effective shelf width D. An air inlet port and an air outlet port maybe collectively referred to as air inlet/outlet ports. Also, in the case of D=L, L coincides with L1 alone as described below.

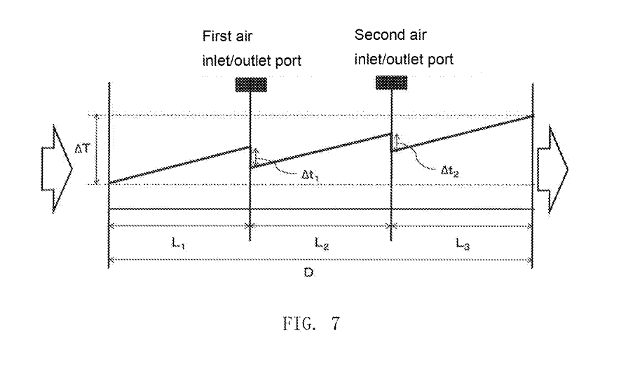

In the case where air is not actively allowed to be introduced into or discharged from the cultivation shelf excluding at an end portion air inlet port 18 and an end portion air outlet port 19, the temperature of the lower part of the shelf-to-shelf space increases along the air blowing direction. However, in the case where air inlet/outlet ports are provided in a place other than the end portion air inlet port 18 and the end portion air outlet port 19 in the cultivation shelf to actively allow an air to be introduced into or discharged from the cultivation shelf, the temperature in the lower part of the shelf-to-shelf space may decrease along the air blowing direction beyond the amplitude range in a short time. In such a case, along the air blowing direction, the distance from the end portion air inlet port 18 to the next air inlet/outlet port, the distance from the air inlet/outlet port to the next air inlet/outlet port provided in the cultivation shelf, or the distance from the air inlet/outlet port provided in the cultivation shelf to the end portion air outlet port 19 may be respectively represented by Li. Li represents a distance [m] between i-th and (i−1)-th air inlet/outlet ports, counted from an end portion air inlet port along the air blowing direction, i starting from 1. For example, FIG. 7 is a schematic diagram of the temperature change (ΔT) in a cultivation shelf having two air inlet/outlet ports, in which the horizontal axis indicates the effective shelf width D and the longitudinal axis indicates the temperature change (ΔT). In this case, since the end portion air inlet port is depicted on the left side of the figure, L is sequentially, from left to right, referred to as L1, L2, L3.

Thus, examples in which the regional temperature in the lower part of the shelf-to-shelf space decreases along the air blowing direction beyond the amplitude range in a short time in the cultivation shelf and/or between the cultivating shelves includes the case where an air supply piping 20 or the like is provided between cultivation shelves or in a cultivation shelf to allow cold air to flow in. It should be noted that the air inlet/outlet port between cultivation shelves or in a cultivation shelf may allow air to introduce/discharge simultaneously or separately.

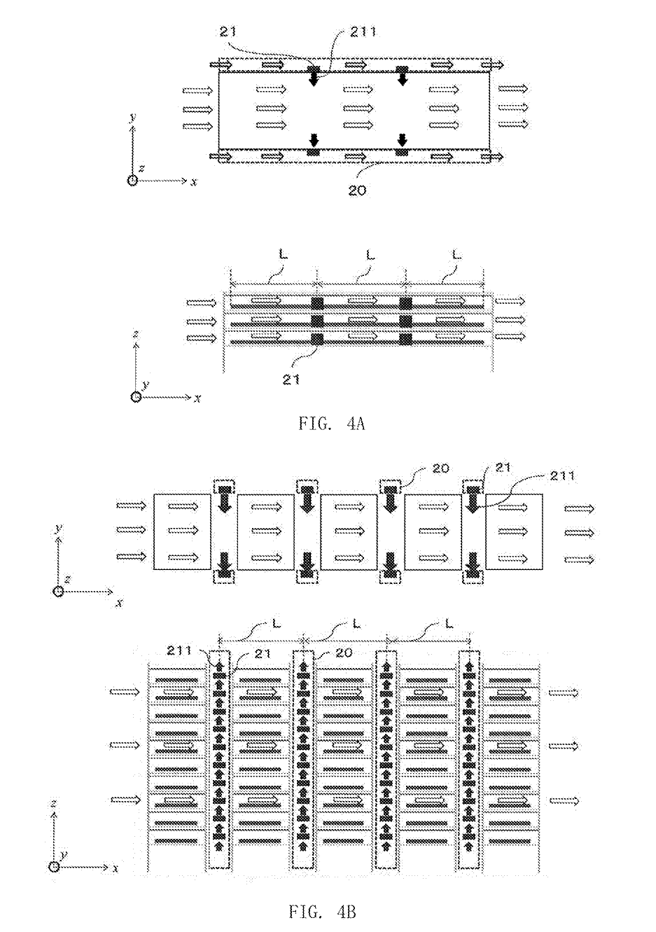

For example, in FIG. 4A, there is provided an air supply piping 20 through which an air conditioned by the air conditioner flows in the direction of the effective shelf width D of each stage of the cultivation shelf 10, and each of the plurality of openings formed in the air supply piping 20 serves as an air inlet/outlet port 21. Further, in FIG. 4B, an air supply piping 20 through which air conditioned by an air conditioner flows is provided between cultivation shelves 10 to extend along the height direction, and each of the plurality of openings provided in the air supply piping 20 is taken as an air inlet/outlet port 21. 211 indicates an air flow blown out through the air inlet/outlet port.

In the case where there is a plurality of air inlet/outlet ports provided in a single cultivation shelf or there are air inlet/outlet ports between a plurality of cultivation shelves spaced from one another at a distance W which is less than 2 m, the distance from one opening to the next opening, which opening respectively serves as an air inlet/outlet port, is indicated by Li. For the air inlet/outlet port 21 existing in the air supply piping 20, the distance may be measured with reference to the center of the air inlet/outlet port.

The present inventors have attempted plant cultivation using multistage cultivation shelves, and have found that an uneven temperature distribution occurs in the air blowing direction in a shelf-to-shelf space 14 in which plants are to be placed when the plants are cultivated in the space to which the air conditioned by an air conditioner is blown.

This phenomenon is considered to be caused by the fact that the heat generated from the lighting device 12 installed in an upper portion of the shelf-to-shelf space 14 is diffused downward, and that the air conditioned by the air conditioner is blown along one direction when the temperature around the plant rises due to heat transfer from the supporting surface 132 warmed by radiation from the lighting device.

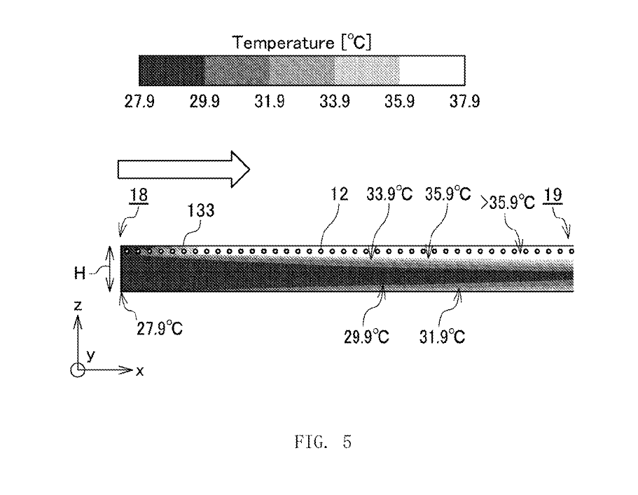

FIG. 5 is a diagram showing a simulation result of a temperature distribution where the effective shelf-to-shelf height H is 300 mm. At the shelf end portion closer to the end portion air inlet port 18 for the air to be blown, the temperature around the plant lowers because of the short distance wherein the air to be blown is exposed to heat from the supporting surface 132 warmed by radiation from the lighting device 12, and because of heat generated from the lighting device 12, which has not been completely diffused downward. On the other hand, the air at the closer to the end portion air outlet port 19 is exposed to the heat in longer distance. The heat is transfer from the supporting surface 132 warmed by the radiation from the lighting device. In addition, the heat generated from the lighting device diffuses downward. Therefore, the temperature around plants tends to rise.

As shown in FIG. 5, when the air adjusted to 27.9° C. is supplied, the temperature around the plant is kept at 27.9° C. at the shelf end close to the end portion air inlet port 18, while the temperature around the plant increases from 29.9° C. to 31.9° C. as it approaches the end portion air outlet port 19.

The inventors of the present invention have studied and found that the temperature distribution around plants which is uneven in the air blowing direction as described above is particularly problematic for balancing space efficiency of shelf-to-shelf space 14 and temperature adjustment especially in the case where the effective shelf width D is increased by scale-up of a cultivation shelf. Therefore, simple scale-up of the conventionally known cultivation shelf cannot provide an facility with high productivity which has well-balanced the space efficiency of the shelf-to-shelf space 14 and the temperature adjustment.

A cultivation shelf used in the present invention is characterized in that the ΔT, obtained according to the following mathematical equation (1) using an effective shelf-to-shelf height (H) and an effective shelf width (D), is 10° C. or less,

wherein, in the mathematical equation (1), (H) is an effective shelf-to-shelf height, i.e., a distance between a top end surface of the holding container and a ceiling surface immediately above the container, and (D) is an effective shelf width obtained according to the mathematical equation (2), i.e., a distance in the direction parallel to the air blowing direction at the holding container placed in the support structure. By satisfying this relationship, it is possible to provide a range that does not hinder the growth of the plants even in the case where there is an uneven temperature distribution around the plants, and by making the shelf-to-shelf space 14 as small as possible, the space efficiency can be enhanced. Such a balance can provide an facility with high productivity.

$$\begin{matrix}[ Math 5 ] & \\ Δ T = \{ \begin{matrix}710.8 \frac{{L}_{1} {Q}^{′}}{{VH}^{1.3}} & ( b = 0 ) \\ {\sum }_{i = 1}^{b + 1} ( 710.8 \frac{{L}_{1} {Q}^{′}}{{VH}^{1.3}} ) - {\sum }_{j = 1}^{b} ( Δ {t}_{j} ) & ( b \geq 1 )\end{matrix} & ( 1 )\end{matrix}$$

In mathematical equation (1), ΔT represents a net temperature increment [° C.] at the lower part of the shelf-to-shelf space in the section having an effective shelf width D; b represents the number of air inlet/outlet ports other than those at the end portion, Li represents a distance [m] between i-th and (i−1)-th air inlet/outlet ports, counted from an end portion air inlet port along the air blowing direction, i starting from 1, Δtj represents a temperature decrement [° C.] at a j-th air inlet/outlet port among the air inlet/outlet ports provided in the cultivation shelf, counted from the end portion air inlet port along the air blowing direction, j starting from 1, Q′ represents a heat input ratio by a lighting device, V represents an air velocity blowing into a shelf-to-shelf space [m/s], H represents an effective shelf-to-shelf height [mm].

Here, the lower part of the shelf-to-shelf space means the range of the plant height when the plants to be cultivated have grown to maturity. From the viewpoint of increasing the space efficiency, this mathematical equation is preferably applied if the height is ¼ or more, more preferably ⅓ or more, still more preferably ½ or more, and ⅔ or less of the effective shelf-to-shelf height measured from the bottom because the plant is less directly affected by heat generated from the lighting device. Ripening growth in variety of vegetables used herein means a state where the plant has its inherent maximum height, i.e., the plant does not become larger any more even if the cultivation time is extended.

[Math 6]

D=Σᵢ₌₁^{b+1}Lᵢ (2)

In mathematical equation (2), D represents an effective shelf width [m], b represents the number of air inlet/outlet ports other than those at the end portion,
Li represents a distance [m] between i-th and (i−1)-th air inlet/outlet ports, counted from an end portion air inlet port along the air blowing direction, i starting from 1.

Here, the above equation (1) is classified into two types according to the presence/absence of an air inlet/outlet port other than the end portion provided in the cultivation shelf.

If the air inlet/outlet port is provided only at the end portion and b=0 and the mathematical equation (2) is D=L1 (L), the following mathematical equation (1-1) maybe applied.

$$\begin{matrix}[ Math 7 ] & \\ Δ T = 710.8 \frac{{L}_{1} {Q}^{′}}{{VH}^{1.3}} & ( 1 \text{-} 1 )\end{matrix}$$

On the other hand, in the case where at least one air inlet/outlet port other than the end portion is provided in the cultivation shelf and b≥1 and D=L1+L2 . . . +Li, the following equation (1-2) may be applied.

$$\begin{matrix}[ Math 8 ] & \\ Δ T = {\sum }_{i = 1}^{b + 1} ( 710.8 \frac{{L}_{1} {Q}^{′}}{{VH}^{1.3}} ) - {\sum }_{j = 1}^{b} ( Δ {t}_{j} ) & ( 1 \text{-} 2 )\end{matrix}$$

Each of the parameters of the above equations (1) and (2) will be described below.

D represents an effective shelf width of a cultivation shelf, specifically a distance in the direction parallel to the air blowing direction in the holding container placed on the support structure. As described above, if a plurality of cultivation shelves are arranged, the sum of the length corresponding to the shelf width of each cultivation shelf is taken as D, when the distance between cultivation shelves is less than 2 m. D is preferably 1 m or more, more preferably 5 m or more, still more preferably 10 m or more, even more preferably 15 m or more, particularly preferably 25 m or more as a general cultivation shelf, and, from the viewpoint of air conditioning efficiency, is preferably 500 m or less, more preferably 400 m or less, still more preferably 300 m or less, even more preferably 200 m or less, particularly preferably 100 m or less.

Li represents a temperature rising section around the plant along the air blowing direction, specifically the distance between the air inlet/outlet ports along the air blowing direction. Therefore, it can be said to be a range where a continuous temperature distribution can be generated from the point at which the conditioned air is supplied. Li represents a distance [m] between i-th and (i−1)-th air inlet/outlet ports, counted from an end portion air inlet port along the air blowing direction, i starting from 1.

b represents the number of times of the temperature around the plant rising along the air blowing direction in the cultivation shelf discontinuously decreases, specifically, the number of air inlet/outlet ports provided in the cultivation shelf other than those at the end portion. Therefore, as described above, if there is no point where the temperature around the plant discontinuously decreases along the air blowing direction on the cultivation shelf, b is 0, and D coincides with L1. On the other hand, if there is(are) (a) point(s) where the temperature around the plant decreases discontinuously on the cultivation shelf or between cultivation shelves, b is 1 or more, and there are a plurality of ranges (Li) wherein a continuous temperature distribution may be generated in D. Examples where b is 1 or more include a case where the air between the cultivation shelves is cooled and a case where the intake and exhaust are separately performed in the middle of the cultivation shelf and the like.

The temperature decrement of the temperature around the plant at the air inlet/outlet port provided in the cultivation shelf is indicated by Δtj. Δtj represents a temperature decrement at the j-th air inlet/outlet port among the air inlet/outlet ports provided in the cultivation shelf, counting sequentially from 1 from the end portion along the air blowing direction. For example, in FIG. 7, since the cultivation shelf has two air inlet/outlet ports, they are indicated by Δt1 and Δt2, respectively, counted sequentially from the left side of the drawing. Each of Δtj, in which j is 1 to j, maybe different or the same. Also, Δtj at each air inlet/outlet port may be decreased to the temperature equal to or higher than the temperature of the end portion air inlet port. Since the effective shelf width D can be increased, it is preferable that Δtj is a temperature decrement from the temperature of the air inlet/outlet port to the temperature equal to the temperature of the end portion air inlet port.

Δtj can be obtained as a difference between the temperature at the temperature measurement point Aj (hereinafter referred to as Aj) within the lower part of the shelf-to-shelf space and the temperature at the temperature measurement point Bj (hereinafter referred to as Bj) within the lower part of the shelf-to-shelf space. Note that Aj and Bj are determined by defining positions in three directions: x direction, y direction and z direction, respectively, in the lower part of the shelf-to-shelf space. The position of the Aj in the x direction is located at a distance of 100 mm in the direction from the center of the j-th air inlet/outlet port to the (j−1)-th air inlet/outlet port. When the half the distance between the center of the j-th air inlet/outlet port and the center of the (j−1)-th air inlet/outlet port is less than 100 mm, the position corresponds to the position between the center of the j-th air inlet/outlet port and the center of the (j−1)-th air inlet/outlet port. Here, the 0-th air inlet/outlet port coincides with the end portion air inlet port. The position of the Aj in the y direction is a position of ½ the length in the y direction (longitudinal direction) of the cultivation shelf and the position in the z direction is a position from the upper end surface of the holding container, the position being any position so long as it may exist within the lower part of the shelf-to-shelf space. The position of the Bj in the x direction is located at a distance of 100 mm in the direction from the center of the j-th air inlet/outlet port to the center of the (j+1)-th air inlet/outlet port. When the half the distance between the center of the j-th air inlet/outlet port and the center of the (j+1)-th air inlet/outlet port is less than 100 mm, the position corresponds to the position between the center of the j-th air inlet/outlet port and the center of the (j+1)-th air inlet/outlet port. Here, the (j+1)-th air inlet/outlet port coincides with the end portion air outlet port. The position of the Bj in the y direction is a position having a length of ½ of the length in the y direction (longitudinal direction) of the cultivation shelf and the position of the Bj in the z direction is a position equal to the position of the Aj in the z direction. Further, when b is 2 or more, all the positions of the respective temperature measurement points Al, . . . , Ab and Bl, . . . and Bb in the z direction are equivalent.

Li is 0.1 m or more, preferably 1 m or more, more preferably 2 m or more, further preferably 3 m or more, even more preferably 4 m or more, particularly preferably 5 m or more since the effect of the present invention is remarkably exhibited, and preferably 200 m or less, more preferably 100 m or less, further preferably 80 m or less, even more preferably 50 m or less, particularly preferably 30 m or less, from the viewpoint of keeping the temperature distribution in the air blowing direction around the plant within a preferable range.

H represents an effective height in each stage of plant cultivation. Specifically, the distance from the top end surface of the holding container to the ceiling surface immediately above the container is an effective shelf-to-shelf height. H may be set appropriately within a suitable range depending on the types of the plants to be cultivated, but it is preferably in the range from 100 mm to 1,000 mm.

Q′ is the heat input ratio by the lighting device, and can be determined by the following equation: Q′=Q/197 W/m, wherein Q means a calorific value from the lighting device and is usually preferably set to 400 W/m or less although a preferable range varies depending on the lighting device to be used. Q may be determined using the following mathematical equation (3).

Q [W/m]=(output of lighting [W])=(the longest length of lighting [m])(arrangement pitch of lighting in the x direction [mm])×1,000 mm (3)

For example, in FIG. 5, when 27 W fluorescent lamps having length of 1.4 m are evenly spaced at 100 mm pitch in the x direction in FIG. 5, Q is 193 W/m. When the 54 W fluorescent lamps having length of 1.4 m are evenly spaced at 100 mm pitch in the x direction in FIG. 5, Q is 386 W/m. Furthermore, LED lightings with a length of 1.4 m and 10 W are evenly spaced at 100 mm pitch in the x direction in FIG. 5, Q is 71 W/m.

V is a wind velocity at the air inlet through which an air is blown into the shelf-to-shelf space. V is preferably 0.05 m/s or more, more preferably 0.1 m/s or more in order to reduce temperature increment around plants, and is preferably 4.0 m/s or less, more preferably 2.0 m/s or less from the viewpoint of operating cost of the air conditioner.

ΔT represents a net temperature increment at the lower part of shelf-to-shelf space of the D section. ΔT is required to be 10° C. or less, preferably 8° C. or less, more preferably 6° C. or less, further preferably 4° C. or less, still more preferably 2° C. or less, particularly preferably 2° C. or less, and particularly preferably 1° C. or less from the viewpoint of plant growth environment.

In order to strictly control the temperature, specifically, in order to control the temperature within the above-mentioned preferable range, the air blowing velocity, when the conditioned air supplied from the air blow port reaches the cultivation shelf, is 0.2 m/s or more, preferably 0.3 m/s or more, more preferably 0.5 m/s or more, and usually 2.0 m/s or less, preferably 1.8 m/s or less, more preferably 1.5 m/s or less. Above the lower limit, the atmosphere of the cultivation shelf can be appropriately controlled, and below the upper limit, the possibility that the cultivation is inhibited by the wind can be reduced.

1. Chamber 15

A chamber is used to contain cultivation shelves and to control plant cultivation environment within a predetermined conditional range. It is enough for a chamber to include at least a floor, side walls, a ceiling, as well as a space for containing a cultivation shelf and a space around the cultivation shelf for work. It is preferable to minimize the space to be controlled for plant cultivation.

On the other hand, a chamber of the present invention can be suitably used as an facility for cultivating plants industrially, in which the length of one side of the chamber is usually 2 m or more, preferably 3 m or more, more preferably 4 m or more, and usually 30 m or less, preferably 20 m or less, more preferably 10 m or less. The height of the ceiling is usually 2 m or more, preferably 2.5 m or more, more preferably 3 m or more, and usually 20 m or less, preferably 15 m or less, more preferably 10 m or less.

Above the lower limit, plants can be efficiently cultivated, and below the upper limit, it becomes easier to control the state inside the chamber. As the height in the chamber becomes high, it becomes difficult to control the temperature. Accordingly, the height may be set according to the required strictness of the temperature control. For example, when the temperature is required to be controlled within about ±2° C. with respect to the target temperature, the height is preferably 10 m or less. However, it also varies depending on the outside air condition at the site and the amount of the heat source in the chamber such as a lighting device. Depending on the outside air condition of the chamber, the side wall surface and the roof may be optionally insulated. It is desirable to use a heat insulating material with a thickness of about 40 mm to 200 mm for heat insulation.

There may exist only one cultivation shelf or a plurality of cultivation shelves in the chamber. When a plurality of cultivating shelves are arranged, it is preferable that the plurality of cultivating shelves are arranged so as to be adjacent to one another on their long sides.

For the side walls, the ceiling and the floor of the chamber, it is preferable to use a material suitable for environmental temperature and environmental humidity for growing plants, in particular, a material not easily corroded by moisture, and it is also preferable to use material having smooth shape in order to prevent dust, dirt, fungus, etc. from adhering to the surface thereof. It is preferable to use a waterproof material so that they can be wiped and cleaned with water or the like even if they adhere. Especially on the floor, a drainage basin or a drainage port for draining sewage are preferably provided for convenience for its cleaning. In this case, a flow stopper is optionally provided in the opening to prevent inadequate leakage during drainage. The surfaces of the inside wall, the ceiling and the floor of the chamber may be subjected to a surface treatment as appropriate in order to provide necessary functions.

Since it is necessary to control the plant cultivation environment, it is also preferable that the airtightness of the chamber be high in order to keep the pressure inside the chamber higher or lower than the atmospheric pressure. When the chamber is equipped with fittings having openings, special attention should be paid to the airtightness of the opening of the fittings. Also, when a plant requiring genetic engineering operation, for example, a plant for protein synthesis is used, it is preferable that the chamber is an architecture which can make the space including the cultivation shelf be a closed system.

From the above requirements, a panel having a heat insulating function or a decorative calcium silicate board is preferably used as a preferable material for the ceiling and the side wall material of the chamber, and a hard urethane material or the like is particularly preferably used as a floor material.

2. Cultivation Shelf 10

2.1 Holding Container 11

A holding container is for cultivating and/or holding a plant. A holding container has the function of holding and/or discharging water as necessary.

Although the shape is arbitrary, a tray-like shape which is relatively thin in the horizontal direction is preferably used since it is desired to vertically stack the holding containers at narrow intervals in order to increase the space efficiency required for plant cultivation facility.

The plant to be held is not particularly limited, but a plant with many leaves is particularly preferably used. Especially, it is preferably used for growing plants for pharmaceuticals, drug development, food, health, requiring relatively strict control within a narrow control range; plants utilizing gene recombination technology; plants for protein synthesis; and plants having the results of their implementation have been accumulated such as leaf vegetables, Arabidopsis thaliana, tobacco, among others.

The shape of the bottom surface, that is, the shape in the horizontal direction is not particularly limited and may be any of a circle, an ellipse, and/or a polygon. But a rectangle is preferable from the viewpoint of space use efficiency.

The holding container may be provided with structures such as a section or gripper for holding or containing plants or the like; a flowing water channel for supplying water, a water supply unit, a drainage unit or the like, as needed.

The material of the holding container is not particularly limited, but resin materials such as ABS, vinyl chloride, polypropylene, polystyrene, acrylic resin, acrylonitrile styrene, polycarbonate, polyurethane, expanded polystyrene and the like and alloys and filler composite materials thereof; metal material such as carbon steel, stainless steel, aluminum steel; wood;, a glass material or the like is generally used. Among others, a resin material is preferable in that components that affect the growth of living things are less likely to generate.

In order to improve the air conditioning efficiency, the holding container should have a minimum necessary capacity and a shape that is advantageous for air flow of the air conditioner, and it is also preferable to arrange the holding containers regularly.

2.2 Lighting Device 12

Since light is necessary for plant cultivation, a lighting device is provided in a cultivation shelf. Specific examples of the case requiring light for cultivation of plants includes the case where the plant requires light for maintaining life for a defined period, the case where light/dark period is required to promote the growth of the plant, the case where light is required to stimulate a bio-hormone to grow the plant in a desired shape and direction, the case where light energy is required to conduct photosynthesis, and the like.

Specific examples of the method of installing the lighting device include
a method of fixing to the bottom surface of another holding container existing above the holding container or to the ceiling surface consisting of the bottom surface of the placing member constituting a support structure by screwing, bolting, welding, bonding, etc. directly or via a fixing member; a method including fixing a fixing member for lighting device prepared by providing the support structure with an engaging member or an irregularity part to a support structure by the aforementioned procedure directly or via a fixing member, and mounting and fixing the lighting device by engaging with the engaging member or the irregularity part so as not to change the position, and the like. At that time, it is preferably arranged so that the plant to be cultivated is uniformly irradiated with light without waste. A reflector may be used for the purpose of appropriately irradiating the plant with light emitted from the lighting device. The reflector is disposed on the back of the light emitting part of the lighting device and has a function of reflecting light emitted in a direction difficult to use for irradiation to plants in a preferable direction. The reflecting plate is not particularly limited so long as it has a surface state and/or color of high reflectance. However, a white or opal-white metal plate or plastic plate having a smooth surface is usually used. The reflection plate is fixed, for example, to a support structure described below.

The lighting device is not limited as far as the object can be achieved, and a known lighting device can be used.

Specific examples of types of the lighting device include a sodium lamp, a mercury lamp, a fluorescent lamp, a metal halide lamp, an ultraviolet lamp, an infrared lamp, a far infrared lamp, a microwave irradiation device, an LED, an electroluminescence, a neon lamp, and the like. Among them, fluorescent lamps and LEDs with high luminous efficiency are preferable. An LED is preferable in terms of less heat emitted from the lighting device toward the plant.

As a specific example of the form of the lighting device, a lighting device wherein a light-emitting portion is housed or enclosed in a cylindrical or flat transparent or translucent case in order to save the installation space and to improve the efficiency of air conditioning may be used. The upper limit of the size in the horizontal direction is usually 3 m or less, preferably 2 m or less, more preferably 1.5 m or less, and the lower limit is 30 cm or more, preferably 50 cm or more, more preferably 1 m or more. If the size is too large, installation operation becomes troublesome, which is not preferable. Conversely, if it is too small, uneven irradiation of light tends to occur, and electrical wiring required for lighting device becomes complicated, which is not preferable.

The waterproof specification may be applied by a method of covering the electric connection part of the lighting device with a cap or the like.

In order not to hamper proper control of the plant cultivation environment of the plant, it is preferable to use a lighting device with high light emission efficiency and small heat generation.

2.3 Support Structure 13

The support structure is used to support a plurality of holding containers in the vertical direction. The support may be fixed or placed.

The method of fixing is not particularly limited as long as the support structure and the holding container are fixed with required strength. The holding container and the support structure are fixed directly or via a connecting member. Specifically, screwing, bolting, welding, bonding and the like can be mentioned. The support structure and the holding container may be fixed on the side or bottom surface of the holding container.

When a connection member is used for fixing, the connection member may be disposed between the support structure and the side surface of the holding container, or may be disposed between the support structure and the bottom surface of the holding container. When the connection member is disposed between the support structure and the bottom surface of the holding container, the holding container is placed directly or indirectly on the top surface of the mounting member described below, for example.

The shape of the support structure is not particularly limited, but pillars made of prism-like or rod-like material are preferably used.

In the case where a holding container is supported by placing it on a support structure, the support structure is composed of a plurality of members on which holding containers may be placed, the member (hereinafter referred to as placing members) being fixed in the vertical direction to a pillar made of a prism-like or rod-like material. The holding container is placed on the placing member.

The support structure has a plurality of placing members in the vertical direction and each member has holding containers thereon. Thus, holding containers may be stacked in multiple layers in vertical direction. A placing member may have a member for aligning the holding containers on the top surface thereof. Examples of such member include rails.

In the case of supporting by placement, the holding container can be handled independently of the support structure, and the holding container can be carried into the support structure from another place and/or can be taken out from the support structure to another place, which is preferable.

In order to facilitate carrying the holding container in/out of the support structure, the placing member preferably includes rollers, rails, belts and the like. By adopting a structure that can be moved only by applying force to the holding container in the direction of carrying in/out, work efficiency can be improved.

In addition, it is preferable that the cultivation shelf has holding containers on a plurality of stages, for example, five or more, ten or more, fifteen or more, twenty or more stages.

Although the material of the support structure and the placing member is not particularly limited, but wood or metallic material such as carbon steel, stainless steel, aluminum steel or the like is preferably used from the viewpoint of high strength. It is more preferable to use metal material which is more stable and has high installation accuracy. In the case of using water for living things growth, metal materials which are resistant to corrosion, such as stainless steel, aluminum steel and alloys thereof are preferred. For the purpose of preventing corrosion, it is also possible to use a metal material which has been appropriately coated, passivated, plated, or the like.

3. Air Conditioner

The chamber 15 is equipped with an air conditioner capable of controlling at least one selected from the group consisting of temperature, humidity, cleanliness, oxygen concentration, and carbon dioxide concentration of the space including the cultivation shelf 10. As the air conditioner, known air conditioners may be used.

In the present invention, a general air conditioning facility may be used as an air conditioner for effectively attaining a preferred cultivation environment for plants, the air conditioning equipment usually including:

a filter having a function of removing dust and microorganisms in the air;

a blower for conveying air;

an air conditioner including:
a heat exchanger for cooling, heating and/or humidifying air; and
a humidifier and/or a dehumidifier; and

a duct facility serving as a conveying path for conveying air to a desired space.

Since it is necessary to control the concentration of oxygen, carbon dioxide, etc. in order to properly cultivate plants, it is possible to achieve uniform gas concentration in a desired space by supplying these gases inside the duct facility, for example through the air blow part 16 into the chamber.

When air conditioning in the whole chamber is conducted, it is preferable that an air blow part of the air conditioner is installed on the side wall surface of the chamber. In this case, it is possible to efficiently conduct air conditioning of the entire space with a minimum facility. On the other hand, when air conditioning is conducted for each shelf-to-shelf space of the cultivation shelf, it is preferable that the air blow part of the air conditioner is installed on the side of the cultivation shelf. Examples of the air blow part of the air conditioner installed for each cultivation shelf include air blow parts such as a blower including an impeller, an electric motor, a casing, and an air regulating device. In this case, there is a tendency to be able to strictly control the air around plants.

Conditions for air conditioning are particularly important in growing plants for protein synthesis.

Conditions for air conditioning requiring a strict cultivation environment for plants for protein synthesis, etc. will be described hereinafter in detail.

For general plants, for example edible or ornamental plants, it is necessary just to achieve the purpose, so the allowable temperature range is wide, for example, the temperature up to about Δ20° C. is acceptable.

However, the amount of protein synthesized by plants for protein synthesis may vary considerably depending on the growing conditions, that is, the atmosphere around the holding container of the cultivation shelf used in the present invention. This is known, for example, in J F Buyel, R. Fischer “Predictive Models for Transient Protein Expression in Tobacco (Nicotiana tabacum L.) Can Optimize Process Time, Yield, and Downstream Costs”, Biotechnology and Bioengineering, Vol. 109, No. 10, October, 2012. The above paper describes an example in which the amount of protein to be synthesized decreases to about ⅓ with only the temperature changes by 5° C.

Therefore, the plant for protein synthesis is usually controlled to be within Δ10° C. (±5° C.), preferably within Δ8° C. (±4° C.), more preferably within Δ6° C. (±3° C.), more preferably within ±5° C. (±2.5° C.), more preferably within Δ4° C. (±2° C.), still more preferably within Δ2° C. (±1° C.), particularly preferably within Δ1° C. (±0.5° C.) in related to the optimal temperature. By controlling the temperature within the above range, the entire plant cultivation facility can efficiently synthesize the desired protein. That is, the plant cultivation facility of the present invention makes it easy to set appropriate air conditioning conditions, and is suitable for cultivating plants for protein synthesis requiring strict temperature control. Although it is suitable for plants for protein synthesis, it may of course apply to edible or ornamental plants requiring strict control on cultivation environment such as temperature.

The size of the air blow part is not limited as long as the above conditions can be realized, but the major diameter of the air blow part is usually 5 cm or more, preferably 10 cm or more, more preferably 20 cm or more, and usually 10 m or less, preferably 5 m or less, more preferably 3 m or less, more preferably 2 m or less.

As the shape of the air blow part, a plain-blowout type, a lattice plate having a blade provided in the longitudinal and/or lateral direction (universal type), or a panel-like form having a perforated plate attached to the air blow surface may be suitably used, and a point-blowout type (nozzle type, conical-shape type using air induction (anemo type/pan type)), a line-blowout type (a slot type) and the like maybe also used.

### EXAMPLES

In order to clarify the temperature distribution in the air blowing direction in the cultivation shelf, a two-dimensional finite volume simulation of air flow and heat flow in the cultivation shelf was conducted.

The two-dimensional finite volume simulation used in this example accurately reproduces the temperature distribution in the air blowing direction in the cultivation shelf, which can be confirmed by the fact that the results of the three-dimensional finite volume simulation in the cultivation chamber of the plant factory conducted by the present inventors match very well with the measurement results of the temperature distribution obtained in the same cultivation chamber.

FIGS. 2, 3A and 3B show an example of a model of a cultivation shelf according to an embodiment of the present invention, and this model represents a single stage of a multi-stage cultivation shelf. This embodiment simulates a cultivation shelf modeled as shown in FIGS. 2, 3A and 3B. Since the air inlet/outlet port is present only at the end portion, D=L1 (L).

The lighting device 12 serves as a heat source, and a heat flow originating from the lighting device 12 is generated inside the cultivation shelf by air flow along the x direction. The shape of the lighting device 12 is not limited and not necessarily circular.

<Parameter for Simulation>

Temperature increment (ΔT) [° C.] at the lower part of the shelf-to-shelf space at an arbitrary position in the cultivation shelf along the air blowing direction may be determined using the following four parameters:

air blowing velocity along the air blowing direction at the entrance of the cultivation shelf: air blowing velocity (V) [m/s],

heat input by a heat source inside the cultivation shelf for each air blowing direction: heat input (Q) [W/m],

a height of a single stage of the cultivation shelf: an effective shelf-to-shelf height (H) [mm], and

a length, along the air blowing direction, of a section in which the heat source is placed in the cultivation shelf: an effective shelf width (D) [m].

In this embodiment, it is assumed that the lengths of the cultivation shelf and the lighting device are 1.4 m in the y direction for normalization, but the lengths of the cultivation shelf and the lighting device in the y direction have no effect on the present embodiment and the result obtained therefrom.

<Results of Simulation>

Two-dimensional finite volume simulation was conducted for the modeled cultivation shelf using the aforementioned four parameters set as follows. As a result of the simulation, the obtained temperature increment values (ΔT) around each plant (lower part of the shelf-to-shelf space) are shown in Tables 1 to 15. The ΔT value in this result was calculated, assuming that the height of the lower part of the shelf-to-shelf space is 80 mm from the top surface of the holding container (⅕ to ⅘ of the effective shelf-to-shelf height).

Air blowing velocity (V): 0.2, 0.4, 0.6, 0.8, 1.0 [m/s]

Heat input (Q): 98.3, 197, 393 [W/m]

Effective shelf-to-shelf height (H): 100, 200, 300, 400 [mm]

Effective shelf width (D): 0.0, 1.0, 2.0, 3.0, 4.0, 5.0, 6.0, 7.0, 8.0, 9.0 [m]

TABLE 1
V = 0.2 m/s, Q = 197 W/m

H [mm]

| | | 100 | 200 | 300 | 400 |
|---|---|---|---|---|---|
| D [m] | 0 | 0.1 | 0.0 | 0.1 | 0.2 |
| | 1 | 12.9 | 0.5 | 1.0 | 1.0 |
| | 2 | 20.4 | 2.8 | 3.0 | 2.6 |
| | 3 | 26.8 | 6.1 | 5.1 | 4.2 |
| | 4 | 33.1 | 9.5 | 7.2 | 5.8 |
| | 5 | 39.5 | 12.7 | 9.3 | 7.4 |
| | 6 | 45.7 | 15.8 | 11.5 | 9.0 |
| | 7 | 52.3 | 19.0 | 13.7 | 10.6 |
| | 8 | 58.5 | 22.2 | 15.8 | 12.2 |
| | 9 | 64.6 | 25.4 | 17.8 | 13.6 |
| | 10 | 59.5 | 27.8 | 18.8 | 14.1 |

TABLE 2
V = 0.2 m/s, Q = 98.3 W/m

H [mm]

| | | 100 | 200 | 300 | 400 |
|---|---|---|---|---|---|
| D [m] | 0 | 0.0 | 0.0 | 0.0 | 0.0 |
| | 1 | 6.2 | 0.3 | 0.1 | 0.2 |
| | 2 | 9.9 | 1.4 | 1.1 | 1.2 |
| | 3 | 13.2 | 2.8 | 2.2 | 1.8 |
| | 4 | 16.4 | 4.4 | 3.3 | 2.6 |
| | 5 | 19.7 | 6.0 | 4.3 | 3.4 |
| | 6 | 22.8 | 7.6 | 5.4 | 4.3 |
| | 7 | 26.1 | 9.2 | 6.5 | 5.1 |
| | 8 | 29.3 | 10.8 | 7.6 | 5.8 |
| | 9 | 32.4 | 12.4 | 8.6 | 6.6 |
| | 10 | 29.8 | 13.5 | 9.2 | 6.9 |

TABLE 3
V = 0.2 m/s, Q = 393 W/m

H [mm]

| | | 100 | 200 | 300 | 400 |
|---|---|---|---|---|---|
| D [m] | 0 | 0.2 | 0.3 | 0.5 | 0.6 |
| | 1 | 28.0 | 3.1 | 3.1 | 2.9 |
| | 2 | 42.5 | 8.3 | 7.2 | 5.9 |
| | 3 | 54.7 | 14.7 | 11.4 | 9.2 |
| | 4 | 66.7 | 21.1 | 15.6 | 12.4 |
| | 5 | 79.1 | 27.5 | 19.9 | 15.6 |
| | 6 | 91.1 | 33.7 | 24.2 | 18.7 |
| | 7 | 104.0 | 40.2 | 28.4 | 21.8 |
| | 8 | 116.2 | 46.5 | 32.7 | 24.8 |
| | 9 | 128.0 | 52.7 | 36.5 | 27.5 |
| | 10 | 118.5 | 56.9 | 38.0 | 28.3 |

TABLE 4
V = 0.4 m/s, Q = 197 W/m

H [mm]

| | | 100 | 200 | 300 | 400 |
|---|---|---|---|---|---|
| D [m] | 0 | 0.0 | 0.0 | 0.0 | 0.0 |
| | 1 | 6.2 | 0.3 | 0.0 | 0.0 |
| | 2 | 10.2 | 1.7 | 0.2 | 0.4 |
| | 3 | 13.6 | 3.2 | 1.1 | 1.4 |
| | 4 | 16.8 | 4.8 | 2.0 | 2.2 |
| | 5 | 20.1 | 6.4 | 3.0 | 2.8 |
| | 6 | 23.2 | 8.0 | 4.0 | 3.4 |
| | 7 | 26.5 | 9.6 | 5.0 | 4.1 |
| | 8 | 29.8 | 11.2 | 6.1 | 4.9 |
| | 9 | 32.8 | 12.8 | 7.1 | 5.6 |
| | 10 | 29.9 | 13.6 | 8.0 | 6.1 |

TABLE 5
V = 0.4 m/s, Q = 98.3 W/m

H [mm]

| | | 100 | 200 | 300 | 400 |
|---|---|---|---|---|---|
| D [m] | 0 | 0.0 | 0.0 | 0.0 | 0.0 |
| | 1 | 3.1 | 0.2 | 0.0 | 0.0 |
| | 2 | 5.1 | 0.9 | 0.1 | 0.1 |
| | 3 | 6.7 | 1.7 | 0.4 | 0.6 |
| | 4 | 8.4 | 2.6 | 0.9 | 1.0 |
| | 5 | 10.0 | 3.4 | 1.3 | 1.3 |
| | 6 | 11.6 | 4.2 | 1.8 | 1.6 |
| | 7 | 13.3 | 5.0 | 2.3 | 1.9 |
| | 8 | 14.9 | 5.8 | 2.8 | 2.2 |
| | 9 | 16.4 | 6.6 | 3.4 | 2.6 |
| | 10 | 14.9 | 7.0 | 3.8 | 2.9 |

TABLE 6
V = 0.4 m/s, Q = 393 W/m

H [mm]

| | | 100 | 200 | 300 | 400 |
|---|---|---|---|---|---|
| D [m] | 0 | 0.0 | 0.0 | 0.0 | 0.0 |
| | 1 | 12.6 | 0.6 | 0.0 | 0.1 |
| | 2 | 20.8 | 2.8 | 1.0 | 1.5 |
| | 3 | 27.4 | 5.3 | 3.1 | 3.4 |
| | 4 | 33.9 | 8.2 | 5.2 | 4.5 |
| | 5 | 40.3 | 11.3 | 7.3 | 6.0 |
| | 6 | 46.5 | 14.4 | 9.4 | 7.6 |
| | 7 | 53.0 | 17.7 | 11.5 | 9.2 |
| | 8 | 59.4 | 20.9 | 13.6 | 10.7 |
| | 9 | 65.5 | 24.1 | 15.7 | 12.2 |
| | 10 | 59.6 | 25.9 | 17.3 | 13.1 |

TABLE 7
V = 0.6 m/s, Q = 197 W/m

H [mm]

| | | 100 | 200 | 300 | 400 |
|---|---|---|---|---|---|
| D [m] | 0 | 0.0 | 0.0 | 0.0 | 0.0 |
| | 1 | 4.1 | 0.2 | 0.0 | 0.0 |
| | 2 | 6.9 | 1.3 | 0.0 | 0.0 |
| | 3 | 9.1 | 2.5 | 0.3 | 0.4 |
| | 4 | 11.3 | 3.6 | 0.8 | 0.9 |
| | 5 | 13.6 | 4.7 | 1.4 | 1.4 |
| | 6 | 15.6 | 5.7 | 2.0 | 1.8 |
| | 7 | 17.8 | 6.8 | 2.7 | 2.2 |
| | 8 | 20.0 | 7.9 | 3.4 | 2.6 |
| | 9 | 22.1 | 8.9 | 4.1 | 3.0 |
| | 10 | 19.9 | 9.5 | 4.6 | 3.4 |

TABLE 8
V = 0.6 m/s, Q = 98.3 W/m

H [mm]

| | | 100 | 200 | 300 | 400 |
|---|---|---|---|---|---|
| D [m] | 0 | 0.0 | 0.0 | 0.0 | 0.0 |
| | 1 | 2.1 | 0.1 | 0.0 | 0.0 |
| | 2 | 3.4 | 0.7 | 0.0 | 0.0 |
| | 3 | 4.6 | 1.3 | 0.1 | 0.2 |
| | 4 | 5.7 | 1.8 | 0.4 | 0.4 |
| | 5 | 6.8 | 2.4 | 0.7 | 0.6 |
| | 6 | 7.8 | 2.9 | 1.0 | 0.8 |
| | 7 | 8.9 | 3.4 | 1.4 | 1.0 |
| | 8 | 10.0 | 4.0 | 1.7 | 1.2 |
| | 9 | 11.0 | 4.5 | 2.1 | 1.4 |
| | 10 | 10.0 | 4.8 | 2.4 | 1.6 |

TABLE 9
V = 0.6 m/s, Q = 393 W/m

H [mm]

| | | 100 | 200 | 300 | 400 |
|---|---|---|---|---|---|
| D [m] | 0 | 0.0 | 0.0 | 0.0 | 0.0 |
| | 1 | 8.3 | 0.4 | 0.0 | 0.0 |
| | 2 | 13.9 | 2.5 | 0.1 | 0.1 |
| | 3 | 18.4 | 4.6 | 0.7 | 1.1 |
| | 4 | 22.8 | 6.8 | 1.9 | 2.3 |
| | 5 | 27.2 | 9.0 | 3.1 | 3.2 |
| | 6 | 31.3 | 11.1 | 4.3 | 4.0 |
| | 7 | 35.7 | 13.3 | 5.7 | 4.8 |
| | 8 | 40.0 | 15.4 | 7.0 | 5.7 |
| | 9 | 44.0 | 17.5 | 8.4 | 6.6 |
| | 10 | 39.9 | 18.6 | 9.5 | 7.3 |

TABLE 10
V = 0.8 m/s, Q = 197 W/m

H [mm]

| | | 100 | 200 | 300 | 400 |
|---|---|---|---|---|---|
| D [m] | 0 | 0.0 | 0.0 | 0.0 | 0.0 |
| | 1 | 3.1 | 0.2 | 0.0 | 0.0 |
| | 2 | 5.2 | 1.1 | 0.0 | 0.0 |
| | 3 | 6.9 | 2.0 | 0.1 | 0.1 |
| | 4 | 8.6 | 2.8 | 0.4 | 0.4 |
| | 5 | 10.2 | 3.6 | 0.9 | 0.8 |
| | 6 | 11.8 | 4.4 | 1.4 | 1.1 |
| | 7 | 13.4 | 5.2 | 2.0 | 1.3 |
| | 8 | 15.1 | 6.0 | 2.5 | 1.6 |
| | 9 | 16.6 | 6.8 | 3.0 | 1.9 |
| | 10 | 15.0 | 7.2 | 3.5 | 2.3 |

TABLE 11
V = 0.8 m/s, Q = 98.3 W/m

H [mm]

| | | 100 | 200 | 300 | 400 |
|---|---|---|---|---|---|
| D [m] | 0 | 0.0 | 0.0 | 0.0 | 0.0 |
| | 1 | 1.5 | 0.1 | 0.0 | 0.0 |
| | 2 | 2.6 | 0.5 | 0.0 | 0.0 |
| | 3 | 3.4 | 1.0 | 0.0 | 0.1 |
| | 4 | 4.3 | 1.4 | 0.2 | 0.2 |
| | 5 | 5.1 | 1.8 | 0.5 | 0.4 |
| | 6 | 5.9 | 2.2 | 0.8 | 0.5 |
| | 7 | 6.7 | 2.6 | 1.0 | 0.6 |
| | 8 | 7.5 | 3.0 | 1.3 | 0.8 |
| | 9 | 8.3 | 3.4 | 1.6 | 1.0 |
| | 10 | 7.5 | 3.6 | 1.8 | 1.1 |

TABLE 12
V = 0.8 m/s, Q = 393 W/m

H [mm]

| | | 100 | 200 | 300 | 400 |
|---|---|---|---|---|---|
| D [m] | 0 | 0.0 | 0.0 | 0.0 | 0.0 |
| | 1 | 6.2 | 0.3 | 0.0 | 0.0 |
| | 2 | 10.5 | 2.1 | 0.0 | 0.0 |
| | 3 | 13.9 | 3.8 | 0.2 | 0.3 |
| | 4 | 17.2 | 5.4 | 0.8 | 1.1 |
| | 5 | 20.5 | 7.1 | 1.7 | 1.8 |
| | 6 | 23.6 | 8.7 | 2.7 | 2.4 |
| | 7 | 26.9 | 10.3 | 3.7 | 3.0 |
| | 8 | 30.2 | 11.9 | 4.7 | 3.6 |
| | 9 | 33.2 | 13.4 | 5.7 | 4.2 |
| | 10 | 29.9 | 14.3 | 6.6 | 4.7 |

TABLE 13
V = 1.0 m/s, Q = 197 W/m

H [mm]

| | | 100 | 200 | 300 | 400 |
|---|---|---|---|---|---|
| D [m] | 0 | 0.0 | 0.0 | 0.0 | 0.0 |
| | 1 | 2.5 | 0.1 | 0.0 | 0.0 |
| | 2 | 4.2 | 0.9 | 0.0 | 0.0 |
| | 3 | 5.6 | 1.6 | 0.0 | 0.0 |
| | 4 | 6.9 | 2.3 | 0.3 | 0.2 |
| | 5 | 8.2 | 2.9 | 0.7 | 0.5 |
| | 6 | 9.5 | 3.5 | 1.1 | 0.7 |
| | 7 | 10.8 | 4.2 | 1.6 | 0.9 |
| | 8 | 12.1 | 4.8 | 2.1 | 1.1 |
| | 9 | 13.3 | 5.5 | 2.5 | 1.4 |
| | 10 | 12.0 | 5.8 | 2.9 | 1.7 |

TABLE 14
V = 1.0 m/s, Q = 98.3 W/m

H [mm]

| | | 100 | 200 | 300 | 400 |
|---|---|---|---|---|---|
| D [m] | 0 | 0.0 | 0.0 | 0.0 | 0.0 |
| | 1 | 1.2 | 0.1 | 0.0 | 0.0 |
| | 2 | 2.1 | 0.5 | 0.0 | 0.0 |
| | 3 | 2.8 | 0.8 | 0.0 | 0.0 |
| | 4 | 3.4 | 1.1 | 0.1 | 0.1 |
| | 5 | 4.1 | 1.5 | 0.4 | 0.2 |
| | 6 | 4.7 | 1.8 | 0.6 | 0.3 |
| | 7 | 5.4 | 2.1 | 0.8 | 0.4 |
| | 8 | 6.1 | 2.4 | 1.1 | 0.5 |
| | 9 | 6.7 | 2.7 | 1.3 | 0.7 |
| | 10 | 6.0 | 2.9 | 1.5 | 0.8 |

TABLE 15
V = 1.0 m/s, Q = 393 W/m

H [mm]

| | | 100 | 200 | 300 | 400 |
|---|---|---|---|---|---|
| D [m] | 0 | 0.0 | 0.0 | 0.0 | 0.0 |
| | 1 | 5.0 | 0.2 | 0.0 | 0.0 |
| | 2 | 8.4 | 1.7 | 0.0 | 0.0 |
| | 3 | 11.1 | 3.2 | 0.1 | 0.1 |
| | 4 | 13.8 | 4.5 | 0.5 | 0.5 |
| | 5 | 16.5 | 5.8 | 1.2 | 1.0 |
| | 6 | 18.9 | 7.0 | 2.1 | 1.5 |
| | 7 | 21.6 | 8.4 | 2.9 | 2.0 |
| | 8 | 24.2 | 9.6 | 3.8 | 2.4 |
| | 9 | 26.6 | 10.9 | 4.7 | 2.9 |
| | 10 | 24.0 | 11.5 | 5.4 | 3.4 |

As an example of the implement embodiment, FIG. 5 shows a contour figure of the temperature distribution in a cultivation shelf wherein

an air velocity (V) is 0.4 m/s,

a heat input (Q) is 197 W/m,

an effective shelf-to-shelf height (H) is 300 mm.

FIG. 5 shows that the temperature inside the cultivation shelf gradually rises from the inlet of the cultivation shelf along the air blowing direction by heat conduction, advection, and convection.

<Mathematical Equation Regarding Optimum Constitution for Cultivation Shelf>

The effective shelf-to-shelf height (H) and the effective shelf width (D) which can keep the temperature around the plant placed in the cultivation shelf within the optimum range for cultivation can be determined by applying the results of the two-dimensional finite volume simulation to the mathematical equation (4) obtained by least squares fitting.

$$\begin{matrix}[ Math 9 ] & \\ Δ T = α \frac{{DQ}^{′}}{{VH}^{n}} & ( 4 )\end{matrix}$$

wherein

α=710.8 K·m/s,

n=1.3,

0.2 m/s≤air velocity (V)≤1.0 m/s,

0.5≤heat input ratio (Q′)=heat input (Q)/197 W/m≤2.0,

100 mm≤effective shelf-to-shelf height (H)≤400 mm,

0.0 m≤effective shelf width (D).

<Determination of Constitution of Cultivation Shelf>

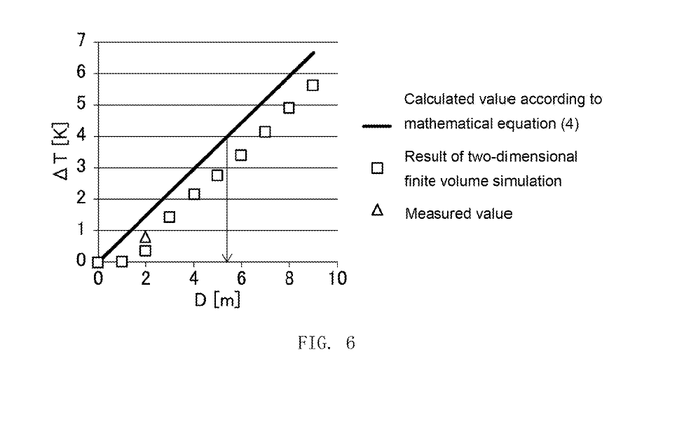

FIG. 6 shows a graph prepared by plotting temperature increment (ΔT) at the lower part of the shelf-to-shelf space against an effective shelf width (D) obtained by mathematical equation (4), wherein air velocity (V) is 0.4 m/s, heat input (Q) is 197 W/m, and effective shelf-to-shelf height (H) is 400 mm.

Under provision of FIG. 6, if the preferred temperature distribution width is 4.0° C., the cultivation shelf having an effective shelf-to-shelf height (H) and an effective shelf width (D) within the range shown as shaded area in FIG. 6 is the cultivation shelf which can control the temperature around the plants within an optimum range for cultivation.

As described above, using the mathematical equation (4) enables easy determination of a cultivation shelf having an effective shelf-to-shelf height (H) and an effective shelf width (D) that can keep the temperature around the plants within an optimum range for cultivation.

While the invention has been described in detail and with reference to specific embodiments thereof, it will be apparent to one skilled in the art that various changes and modifications can be made therein without departing from the spirit and scope thereof.

### REFERENCE SIGNS LIST

10 CULTIVATION SHELF
11 HOLDING CONTAINER
111 TOP END SURFACE
12 LIGHTING DEVICE
13 SUPPORT STRUCTURE
131 PILLAR
132 SUPPORTING SURFACE
133 CEILING SURFACE
134 PARTITION MEMBER
14 SHELF-TO-SHELF SPACE
15 CHAMBER
16 AIR BLOW PART
17 AIR SUCTION PART
18 END PORTION AIR INLET PORT
19 END PORTION AIR OUTLET PORT
20 AIR SUPPLY PIPING
21 AIR INLET/OUTLET PORT
211 AIR FLOW BLOWN OUT THROUGH THE AIR INLET/OUTLET PORT

What is claimed is:

1. A plant cultivation facility which comprises a cultivation shelf and an air conditioner in a chamber having a floor, side walls, and a ceiling, wherein an air blow part of the air conditioner is disposed on a side wall surface of the chamber so that the air in the whole chamber can be conditioned, and wherein an air suction part is disposed on a side wall surface opposed to said side wall surface; the plant cultivation shelf comprising:
a holding container for holding a plant,
a lighting device, and
a support structure including a plurality of stages which are arranged in heightwise direction and each include:
a supporting surface on which the holding container may be placed, and
a ceiling surface which is opposed to the supporting surface and on which the lighting device may be placed above the holding container;
wherein ΔT, obtained according to a mathematical equation (1) below using an effective shelf-to-shelf height (H) and an effective shelf width (D), is 10° C. or less, wherein, in the mathematical equation (1), (H) is an effective shelf-to-shelf height, i.e., a distance between a top end surface of the holding container and a ceiling surface immediately above the container, and (D) is an effective shelf width obtained according to a mathematical equation (2), i.e., a distance in the direction parallel to an air blowing direction at the holding container placed in the support structure:
$$\begin{matrix}[ Math 1 ] & \\ Δ T = \{ \begin{matrix}710.8 \frac{{L}_{1} {Q}^{′}}{{VH}^{1.3}} & ( b = 0 ) \\ {\sum }_{i = 1}^{b + 1} ( 710.8 \frac{{L}_{1} {Q}^{′}}{{VH}^{1.3}} ) - {\sum }_{j = 1}^{b} ( Δ {t}_{j} ) & ( b \geq 1 )\end{matrix} & ( 1 )\end{matrix}$$
(in the mathematical equation (1):
ΔT represents a net temperature increment [° C.] at a lower part of shelf-to-shelf space in a section having an effective shelf width D;
b represents the number of air inlet/outlet ports other than those at end portions, Li represents a distance [m] between i-th and (i−1)-th air inlet/outlet ports counted from an end portion air inlet port along the air blowing direction, i starting from 1,
Δtj represents a temperature decrement [° C.] at a j-th air inlet/outlet port among the air inlet/outlet ports provided in the cultivation shelf, counted from the end portion air inlet port along the air blowing direction, j starting from 1,
Q′ represents a heat input ratio by a lighting device,
V represents an air velocity blowing into a shelf-to-shelf space [m/s],
H represents an effective shelf-to-shelf height [mm]);
[Math 2]
D=Σᵢ₌₁^{b+1}Lᵢ (2)
(in the mathematical equation (2):
D represents an effective shelf width [m],
b represents the number of air inlet/outlet ports other than those at the end portion,
Li represents a distance [m] between i-th and (i−1)-th air inlet/outlet ports, counted from the end portion air inlet port along the air blowing direction, i starting from 1).

2. The plant cultivation facility according to claim 1, wherein the length (Li) between air inlet/outlet ports along the air blowing direction is 2 m or more.

3. The plant cultivation facility according to claim 1, wherein the effective shelf width (D) is 15 m or more.

4. The plant cultivation facility according to claim 1, wherein the number of air inlet/outlet ports other than those at the end portion (b) is 1 or more.

5. The plant cultivation facility according to claim 1, wherein the lightening device is a fluorescent lamp.

6. The plant cultivation facility according to claim 1, wherein the lightening device is an LED.

7. The plant cultivation facility according to claim 1, wherein the plant is a plant for protein synthesis.

8. The plant cultivation facility according to claim 1, wherein the air blow part of the air conditioner is further placed on the side surface of the cultivation shelf so as to enable air-conditioning for each shelf-to-shelf space of the cultivation shelf.

9. The plant cultivation facility according to claim 1, wherein a plurality of cultivation shelves are arranged.

10. A cultivation shelf used for cultivating plants in a space to which an air conditioned by an air conditioner is blown, the cultivation shelf comprising:
a holding container for holding a plant,
a lighting device, and
a support structure including a plurality of stages which are arranged in heightwise direction and each include:
a supporting surface on which the holding container may be placed, and
a ceiling surface which is opposed to the supporting surface and on which the lighting device may be placed above the holding container;
wherein ΔT, obtained according to a mathematical equation (1) below using an effective shelf-to-shelf height (H) and an effective shelf width (D), is 10° C. or less, wherein, in the mathematical equation (1),
(H) is an effective shelf-to-shelf height, i.e., a distance between a top end surface of the holding container and a ceiling surface immediately above the container, and
(D) is an effective shelf width obtained according to a mathematical equation (2), i.e., a distance in a direction parallel to an air blowing direction at the holding container placed in the support structure:
$$\begin{matrix}[ Math 3 ] & \\ Δ T = \{ \begin{matrix}710.8 \frac{{L}_{1} {Q}^{′}}{{VH}^{1.3}} & ( b = 0 ) \\ {\sum }_{i = 1}^{b + 1} ( 710.8 \frac{{L}_{1} {Q}^{′}}{{VH}^{1.3}} ) - {\sum }_{j = 1}^{b} ( Δ {t}_{j} ) & ( b \geq 1 )\end{matrix} & ( 1 )\end{matrix}$$
(in the mathematical equation (1):
ΔT represents a net temperature increment [° C.] at a lower part of shelf-to-shelf space in a section having an effective shelf width D;
b represents the number of air inlet/outlet ports other than those at the end portion,
Li represents a distance [m] between i-th and (i−1)-th air inlet/outlet ports, counted from an end portion air inlet port along an air blowing direction, i starting from 1,
Δtj represents a temperature decrement [° C.] at a j-th air inlet/outlet port among the air inlet/outlet ports provided in a cultivation shelf, counted from the end portion air inlet port along the air blowing direction, j starting from 1,
Q′ represents a heat input ratio by a lighting device,
V represents an air velocity blowing into shelf-to-shelf space [m/s],
H represents an effective shelf-to-shelf height [mm]);
[Math 4]
D=Σᵢ₌₁^{b+1}Lᵢ (2)
(in the mathematical equation (2):
D represents an effective shelf width [m];
b represents the number of air inlet/outlet ports other than those at end portions,
Li represents a distance [m] between i-th and (i−1)-th air inlet/outlet ports, counted from the end portion air inlet port along the air blowing direction, i starting from 1).
